(19) United States
(12) Patent Application Publication
(10) Pub. No.: US 2002/0174239 A1
(43) Pub. Date: Nov. 21, 2002

(54) Data reproducing apparatus, data reproduction method, recording medium storing data reproduction program, and video on demand system

(75) Inventor: Akihiro Oue, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/135,376

(22) Filed: May 1, 2002

(30) Foreign Application Priority Data
May 21, 2001 (JP) P2001-150968

(51) Int. Cl. G06F 15/16

(52) U.S. Cl. 709/229; 709/231

(57) ABSTRACT

An apparatus for reproducing digital data includes: a storage unit configured to store the digital data including a non-encoded preceding data part and an encoded following data part; an input unit configured to accept instruction to reproduce the digital data; a communication unit configured to request key data for decoding the following data part and to receive the key data from a server; a decoding unit configured to decode the following data part using the key data received; a reproduction unit configured to reproduce the digital data; and a control unit configured to control each of the unit to request the key data with the communication unit and to reproduce the preceding data part with the reproduction unit in parallel, to decode the following data part with the decoding unit using the key data, and to reproduce the following data part after reproducing the preceding data part.

### CROSS REFERENCE TO RELATED APPLICATIONS

This application claims benefit of priority under 35 USC §119 to Japanese Patent Application No. 2001-150968 filed on Mar. 21, 2001, the entire contents of which are incorporated by reference herein.

### BACKGROUND OF THE INVENTION

1. Field of the Invention

The present invention pertains to data reproducing apparatus to reproduce digital data such as sound or video, and in particular pertains to the data reproducing apparatus for acquiring key data for decoding the coded digital data and reproducing the decoded digital data.

2. Description of Related Art

Streaming technology to reproduce while reading digital data such as sound or video attracts attention, and, for example, application to service of video on demand (VoD) is expected by the streaming methodology.

However, a line of high speed/high dignity is necessary in order to reproduce in real-time while reading digital data from a server in a distant place. Therefore, digital data is usually compressed by encoding (data compression) methodology of various methods, and a quantity of transmission is reduced.

In addition, digital data such as sound or video is encoded by coding methodology of various methods, the encoded digital data is recorded to recording media such as a Compact Disc Read-Only Memory (CD-ROM) or a Digital Versatile Disc Read-Only Memory (DVD-ROM), and there is a video on demand system as shown in FIG. 1 of a form to distribute to a user in advance.

In a video on demand system shown in FIG. 1, the encoded video data stored in the recording medium distributed to a user in advance is transferred and recorded to storage unit 404 in client 400 as a data reproducing apparatus.

A user of the video on demand system instructs the reproduction of the video data from input unit 401 of client 400. Control unit 402, having accepted the instructions, controls communication unit 404 to request key data to decode the reproduced digital data to server 500.

Control unit 502 of the server 500, having received the request of the key data from the client 400 via communications network 300, controls communication unit 503 to send back the key data stored in storage unit 501 to the client 400.

The client 400, having received the key data from the server 500 via communications network 300, reads out the video data from the storage unit 404 sequentially, decodes a code of the read out video data using the key data in decoding unit 405, and reproduces the decoded video data in reproduction unit 407 sequentially.

As thus described, the video data encoded in advance will be distributed to the client 400 side, and only the key data is transmitted from the server 500. In this way, even if a line of the communications network 300 is not high-speed, the video data can be reproduced by streaming.

However, in the video on demand system such as the above, there were the following problems.

Generally, proper time is needed for establishment of a communication channel with the use of a communications network. Therefore, as illustrated in FIG. 2, as the time t2 from the request of the key data by the client 400 for the server 500 until the reception of the key data by the server 500 increases, the time (access time) t1 from the instruction of the reproduction by the user until the reproduction of the digital data 10 being actually started is also increases. In other words, even if the user sends in instructions of reproduction, the reproduction is not started immediately. As a result, the user undergoes stress.

### SUMMARY OF THE INVENTION

An apparatus for reproducing digital data in an embodiment of the present invention, the apparatus configured to decode the encoded digital data using key data acquired from a server and to reproduce the decoded digital data, includes: a storage unit configured to store the digital data including a non-encoded preceding data part and an encoded following data part, coming after the preceding data part; an input unit configured to accept instruction to reproduce the digital data stored in the storage unit; a communication unit configured to request key data for decoding the following data part from the server and to receive the key data from the server; a decoding unit configured to decode the following data part of the digital data stored in the storage unit using the key data received by the communication unit: a reproduction unit configured to reproduce the digital data; and a control unit configured to control each of the unit to request the key data from the server with the communication unit and to reproduce the preceding data part of the digital data with the reproduction unit in parallel, with instructing reproduction with the input unit, to decode the following data part of the digital data with the decoding unit using the key data received by the communication unit, and to reproduce the following data part decoded by the decoding unit after reproducing the preceding data part of the digital data by the reproduction unit.

An apparatus for reproducing digital data in another embodiment of the present invention, the apparatus configured to decode the encoded digital data using key data acquired from a server and to reproduce the decoded digital data, the apparatus comprising: a storage unit configured to store a non-encoded preceding data part of the digital data; an input unit configured to accept instruction to reproduce the digital data; a communication unit configured to request an encoded following data part, coming after the preceding data part, and the key data for decoding the following data part from the server and to receive the key data from the server; a decoding unit configured to decode the following data part of the digital data using the key data received by the communication unit; a reproduction unit configured to reproduce the digital data; and a control unit configured to control each of the unit to request the key data and the following data part from the server with the communication unit and to reproduce the preceding data part of time digital data with the reproduction unit in parallel, with instructing reproduction with the input unit, to decode the received following data part of the digital data with the decoding unit using the key data received by the communication unit, and to reproduce the following data part decoded by the decoding unit after reproducing the preceding data part of the digital data by the reproduction unit.

A computer implemented method for decoding encoded digital data using key data acquired from a server and for reproducing the decoded digital data in an embodiment of the present invention, includes: accepting instruction to reproduce the digital data, stored in a storage unit, including a non-encoded preceding data part and an encoded following data part, coming after the preceding data part; requesting the key data for decoding the following data part from the server with a communication unit; reproducing the preceding data part of the digital data with a reproduction unit in parallel with the requesting of the key data; receiving the key data from the server with the communication unit; decoding the following data part of the digital data with a decoding unit using the received key data; and reproducing the decoded following data part by the reproduction unit after reproducing the preceding data part of the digital data.

A computer implemented method for decoding encoded digital data using key data acquired from a server and for reproducing the decoded digital data in another embodiment of the present invention, includes; accepting instruction to reproduce the digital data, stored in a storage unit, including a non-encoded preceding data part; requesting an encoded following data part, coming after the preceding data part, and the key data for decoding the following data part from the server with a communication unit; reproducing the preceding data part of the digital data with a reproduction unit in parallel with the requesting of the key data and the following data part; receiving the key data and the following data part from the server with the communication unit; decoding the following data part with a decoding unit using the received key data; and reproducing the decoded following data part by the reproduction unit after reproducing the preceding data part of the digital data.

A system of video on demand for decoding encoded digital data using key data and for reproducing the decoded digital data in an embodiment of the present invention, the system comprising: a server configured to store the key data for decoding the encoded digital data; and a client configured to store the digital data including a non-encoded preceding data part and an encoded following data part, coming after the preceding data part, in a storage unit, to request the key data from the server with a communication unit and to reproduce the preceding data part of the digital data with a reproduction unit in parallel, with instructing reproduction with an input unit, to decode the following data part of the digital data with a decoding unit using the key data received by the communication unit from the server, and to reproduce the following data part decoded by the decoding unit after reproducing the preceding data part of the digital data by the reproduction unit.

A system of video on demand for decoding encoded digital data using key data and for reproducing the decoded digital data in another embodiment of the present invention, includes: a server configured to store an encoded following data part of the digital data and the key data for decoding the following data part; and a client configured to store a non-encoded preceding data part of the digital data in a storage unit, to request the key data and the following data part from the server with a communication unit and to reproduce the preceding data part of the digital data with a reproduction unit in parallel, with instructing reproduction with an input unit, to decode the received following data part of the digital data with a decoding unit using the key data received by the communication unit from the server, and to reproduce the following data part decoded by the decoding unit after reproducing the preceding data part of the digital data by the reproduction unit.

A computer readable recording medium storing a program for decoding encoded digital data using key data acquired from a server and for reproducing the decoded digital data in all embodiment of the present invention, includes: accepting instruction to reproduce the digital data, stored in a storage unit, including a non-encoded preceding data part and an encoded following data part, coming after the preceding date part; requesting the key data for decoding the following data part from the server with a communication unit; reproducing the preceding data part of the digital data with a reproduction unit in parallel with the requesting of the key data; receiving the key data from the server with the communication unit; decoding the following data part of the digital data with a decoding unit using the received key data; and reproducing the decoded following data part by the reproduction unit after reproducing the preceding data part of the digital data.

A computer readable recording medium storing a program for decoding encoded digital data using key data acquired from a server and for reproducing the decoded digital data in another embodiment of the present invention, includes: accepting instruction to reproduce the digital data, stored in a storage unit, including a non-encoded preceding data part; requesting an encoded following data part, coming after the preceding data part, and the key data for decoding the following data part from the server with a communication unit; reproducing the preceding data part of the digital data with a reproduction unit in parallel with the requesting of the key data and the following data part; receiving the key data and the following data part from the server with the communication unit; decoding the following data part with a decoding unit using the received key data; and reproducing the decoded following data part by the reproduction unit after reproducing the preceding data part of the digital data.

### BRIEF DESCRIPTION OF THE DRAWINGS

FIG. 1 is a schematic configuration showing a typical example of a video on demand system.

FIG. 2 is a timing chart showing a timing of processing procedure of a client in the video on demand system shown in FIG. 1.

FIG. 3 is a schematic configuration showing configuration of a video on demand system according to a first embodiment.

FIG. 4A is an image diagram showing configuration of digital data used for the video on demand system shown in FIG. 1.

FIG. 4B is an image diagram showing configuration of digital data used for the video on demand system shown in FIG. 3.

FIG. 4C shows an example interposed of a non-coding start signal and coding start signal in the digital data shown in FIG. 4B.

FIG. 5 is a timing chart showing a timing of processing procedure of a client in the video on demand system shown in FIG. 3.

FIG. 6 is a flow chart showing a processing procedure of the client in the video on demand system shown in FIG. 3.

FIG. 7 is a flow chart showing a processing procedure of a client in a video on demand system according to a second embodiment.

FIG. 8 is a flow chart showing a processing procedure of a client in a video on demand system according to a third embodiment.

FIG. 9 is a schematic configuration showing configuration of the video on demand system according to the third embodiments.

FIG. 10 is a schematic configuration showing configuration of a video on demand system according to a fourth embodiment.

FIG. 11 is a timing chart showing a timing of processing procedure of a client in the video on demand system shown in FIG. 10.

FIG. 12 is a flow chart showing a processing procedure of the client in the video on demand system shown in FIG. 10.

### DETAILED DESCRIPTION

There will be explained below embodiments of the present invention with reference to the drawings. It is to be noted that the same or similar reference numerals are applied to the same or similar parts and elements throughout the drawings, and description of the same or similar parts and elements will be omitted or simplified.

In embodiments shown in the following, a preceding data part of digital data, including converted information such as character, sound, a still image, a moving image, is not encoded, to a digital signal, a following data part only is encoded, and the digital data will be distributed to a user in advance. The user stores the digital data to a storage unit of a client as a data reproducing apparatus and instructs the reproduction of the digital data.

Once the instruction to reproduce is made, the client requests key data to decode from a server and reproduces the preceding data part of the digital data in parallel. Therefore, the client goes ahead with reproduction of the non-encoded preceding data part until the key data has been sent by the server. Moreover, once the key data has been sent by the server, while decoding the encoded following data part, the decoded following data part are reproduced following on from the preceding data part continuously. In other words, the client goes ahead with reproduction of the preceding data part without being dependent on the response time for the key data from the server. Therefore, the time (access time) from the instruction to reproduce by the user until the reproduction of the digital data is actually started can be greatly reduced.

Herein, “the request of the key data from the server” and “the reproduction for the precedence part of the digital data” may be done simultaneously, or either, one is begun and the other may be done later. If shortening of the time from the user's instruction to reproduce until the reproduction of the digital data is started (access time) is to be given priority, “the reproduction for the precedence part of the digital data” may be done before “the request of the key data from the server”, or both of them may be done; simultaneously.

In addition, the length of the preceding data part in the digital data is one that will be completed in the times from the request of the key data from the server until the key data has been sent.

In addition, the client can be composed exclusively as data reproduction hardware. All or at least one part of a configuration element of the data reproducing apparatus is composed by software; it can be realized by executing the software in a personal computer.

### First Embodiment

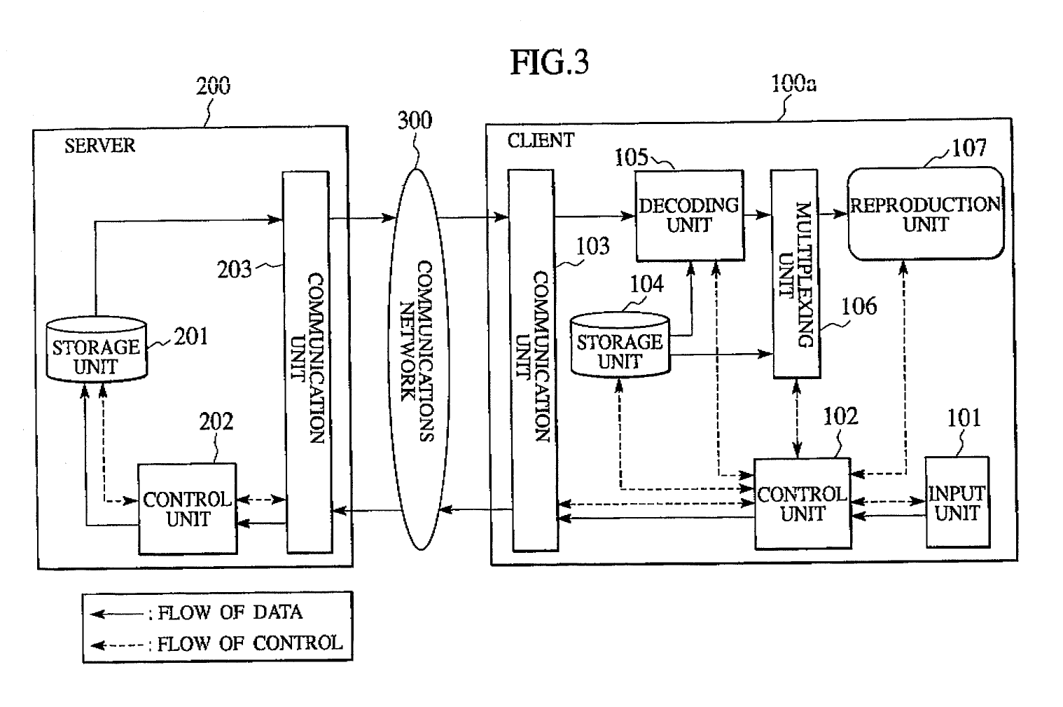

As illustrated in FIG. 3, a video on demand system in a first embodiment includes a client 100a as a data reproducing apparatus and a server 200. The client 100a and the server 200 are connected in communications network 300 its Internet.

Client 100a, which is the data reproducing apparatus, includes an input unit 101, a control unit 102, a communication unit 103, a storage unit 104, a decoding unit 105, a multiplexing unit 106, and a reproduction unit 107. In the storage unit 104, digital data such as sound or video distributed to a user in advance are stored. A distribution method to the user is, for example, a method to distribute a record media such as CD-ROM or DVD-ROM storing the digital data, or a method to transmit via the communication media. As for the stored digital data, a preceding data part of predetermined length is non-encoded from the top, and a following data part coming after the preceding data part is encoded by a predetermined code system. The input unit 101 accepts an instruction to reproduce of the digital data stored in the storage unit 104. The communication unit 103 communicates with the server 200 over the communications network 300. More concretely, the communication unit 103 requests the key data to decode the following data part of the digital data from the server 200 and receives the key data from the server 200. The decoding unit 105 decodes the following data part of the digital data stored in the storage unit 104 using the key data received by the communication unit 103. The multiplexing unit 106 sends the preceding data part of the digital data stored in the storage unit 104 and sends the following data part decoded in the decoding unit 105 to the reproduction unit 107 sequentially. The reproduction unit 107 reproduces the digital data sent from the multiplexing unit 106. The control unit 102 controls each unit composing client 100a according to a processing procedure to be described below.

In addition, the processing procedure to be described below can be distributed as a data reproduction program stored in various record media or transmitted by the communication media. The distributed data reproduction program stores in the storage unit 104 of a client, for example. The control unit 102 of client 100a carries out the control of each unit according to a processing procedure described in the data reproduction program.

The server 200 includes a storage unit 201, a control unit 202, and a communication unit 203. The storage unit 201 stores the key data to decode the code of the following data part of the digital data. The communication unit 203 communicates with the client 100a over the communications network 300. The control unit 202 controls each unit composing the server 200. The digital data such as sound or video is distributed to a recording medium such as for example CD-ROM and DVD-ROM to the user in advance, and the distributed digital data is stored in the storage unit 104 of the client 100a. A method of distribution of the digital data is not limited to the methods above, for example, the digital data may be transferred to the storage unit 104 in client 100a over the transmission medium of the communications network 300.

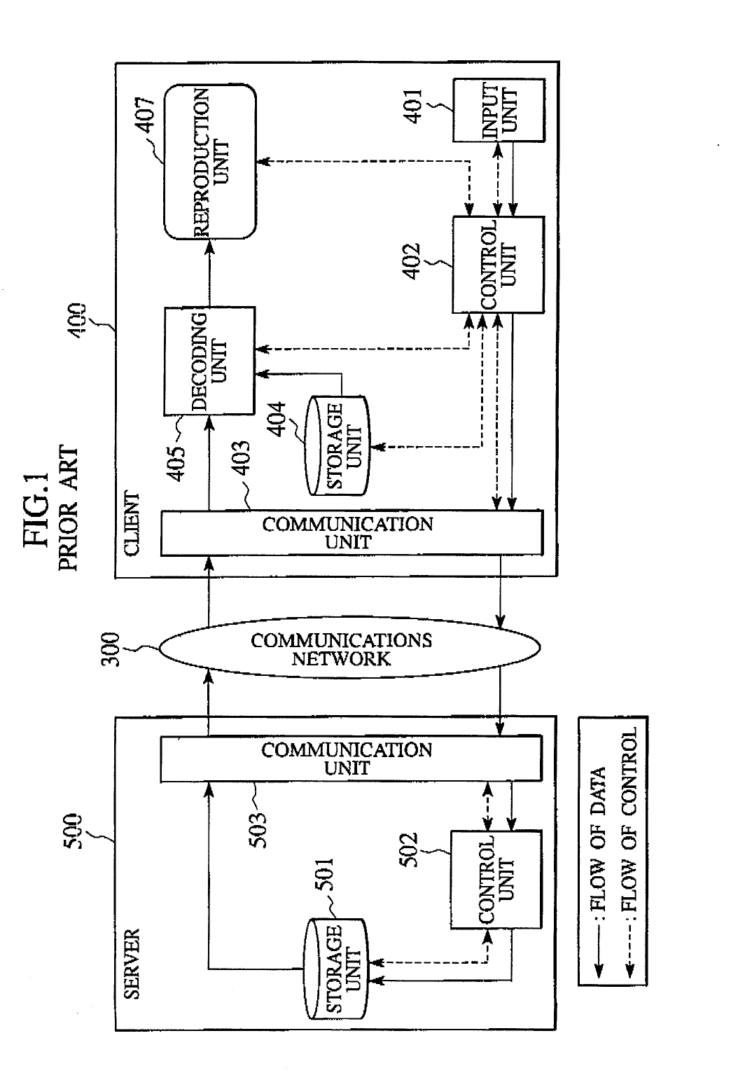

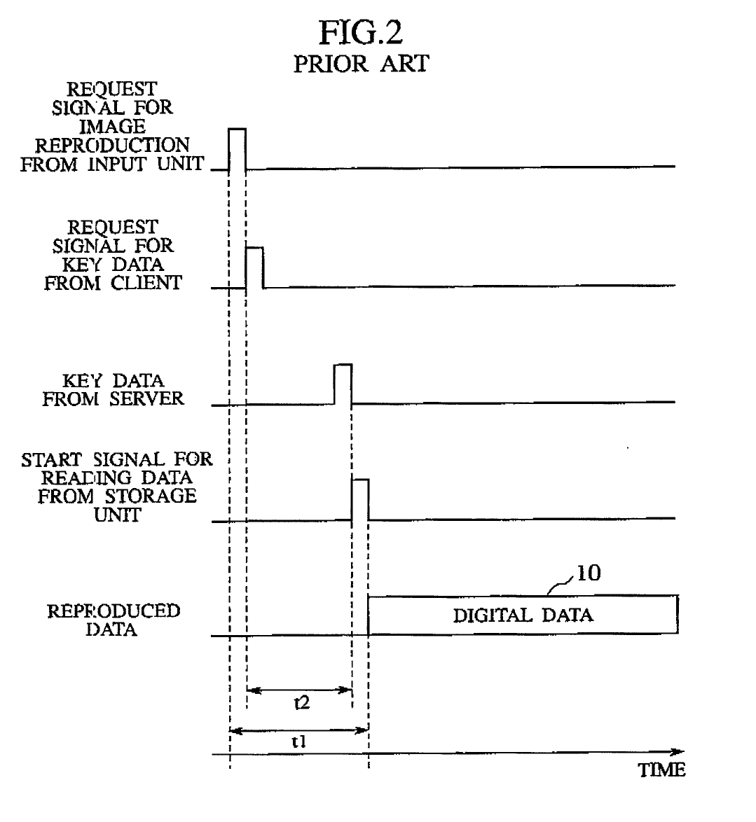

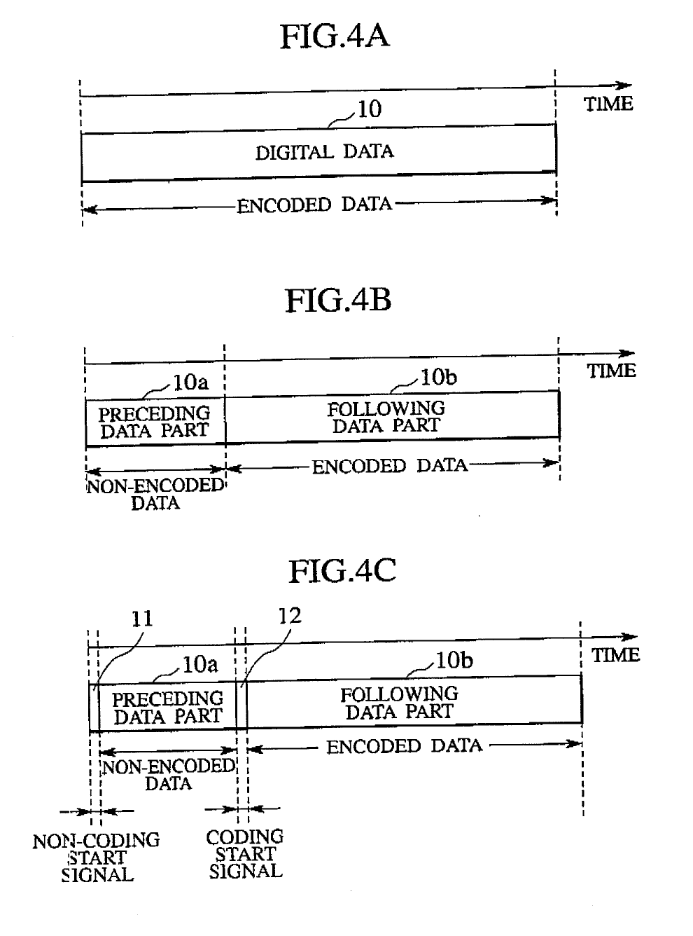

FIG. 4A shows a state of the digital data distributed to the user by the video on demand system illustrated in FIG. 1. Coding is given as against the whole of digital data 10.

As against it, FIG. 4B shows a state of the digital data distributed to the user in the first embodiment. The preceding data part 10a of a predetermined length is not encoded from the top. The following data part 10b coming after the preceding data part 10a is encoded in advance by a predetermined code system. The length of the preceding data part in the digital data is one that will be completed in the time from the request of the key data from the server until the key data has been sent.

In addition, FIG. 4C shows the example interposed coding start signal 12 in the top of the preceding data part 10a and interposed non-coding start signal 11 between the preceding data part 10a and the following data part 10b.

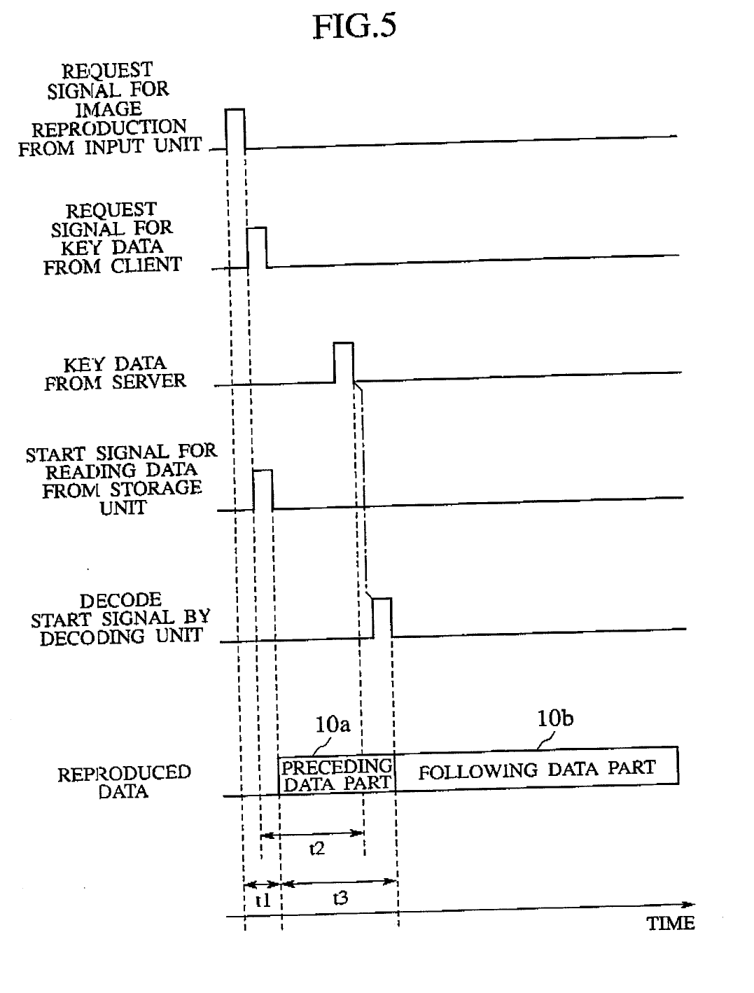

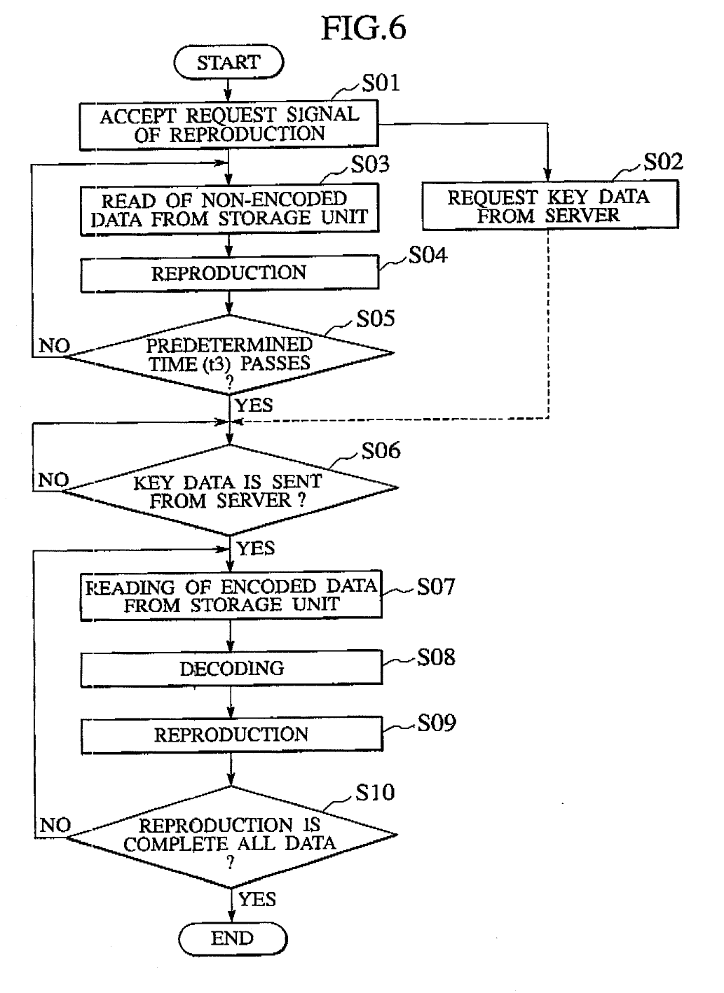

A processing operation of the video on demand system in the first embodiment composed as above is described are based on a time chart illustrated in FIG. 5 and a flow chart illustrated in FIG. 6.

At first, in step S01, the input unit 101 of the client 100a accepts a request signal for the reproduction of the digital data from the user.

The control unit 102 of the client 100a carries out the processing (a) and (b) in parallel, with the request signal to reproduce as a trigger.

(a) In step S02, the control unit 102 controls the communication unit 103 to request the key data for decoding the code of the following data part 10b of the digital data from the server 200. The communication unit 103 sends a request signal for the key data to server 200 over the communications network 300.

(b) In step S03, the control unit 102 sends a reading start signal to multiplexing unit 106. The multiplexing unit 106 starts reading out the preceding data part 10a of the digital data stored in the storage unit 104. The multiplexing unit 106 sends the read preceding data part 10a of the digital data to the reproduction unit 107 sequentially. In step S04, the reproduction unit 107 reproduces and outputs the preceding data part 10a sent from the multiplexing unit 106.

At this time, because the preceding data part 10a of the digital data is non-encoded, even without the key data, the reproduction unit 107 is able to reproduce the preceding data part 10a.

After starting reading out the preceding data part 10a from the storage unit 104, the multiplexing unit 106 measures the progress time, in step S05, the multiplexing unit 106 determines whether the predetermined time t3 has elapsed. The predetermined time t3 corresponds to the length determined as the preceding data part 10a of the digital data. Processing from step S03 to step S04 is repeated until the predetermined time t3 has elapsed.

In the meantime, the control unit 202 of server 200 accepts the request of the key data received by the communication unit 203 from the client 100a over the communications network 300. The control unit 202 reads the key data stored in the storage unit 201. The communication unit 203 transmits the read key data to the client 100a.

When the control unit 102 of client 100a confirms that the communication unit 103 has received the key data in step S06, the control unit 102 sends the received key data to the decoding unit 105 and sends a decode start signal to the decoding unit 105.

In step S07, the decoding unit 105 starts reading out the following data part 10b of the digital data stored in the storage unit 104.

In step S08, the decoding unit 105 decodes the following data part 10b of the read digital data using the key data received by the communication unit 103 and sends the decoded digital data to multiplexing unit 106. The multiplexing unit 106 sends the decoded following data part 10b after the preceding data part 10a to the reproduction unit 107 sequentially.

In step S09, the reproduction unit 107 reproduces and outputs the sent following data part 10b. Until all the processing of the following data part 10b is finished, processing from step S07 to step S09 is repeated (step S10).

As thus described, once the instruction to reproduce is made by a user in the video on demand system in the first embodiment, the requesting of the key data to decode the code to server 200 and reproduction of the preceding data part 10a of the digital data are done in parallel. Therefore, the client 100a goes ahead with reproduction of the non-encoded preceding data part 10a until the key data has been sent by the server 200. If the key data has been sent by the server 200, while decoding the encoded following data part 10b, the client 100a is able to reproduce the following data part 10b after reproducing the preceding data part 10a. In this way, the client 100a is able to go ahead with reproduction of the preceding data part 10a without depending on the response time t2 of the key data from server 200. Therefore, the access time t1 from the user's instruction to reproduce until the reproduction of the digital data is actually started can be greatly reduced.

### Second Embodiment

In a first embodiment, an example of carrying out “the request of the key data front the server” and “the reproduction of the precedence data part of the digital data” In parallel simultaneously was shown.

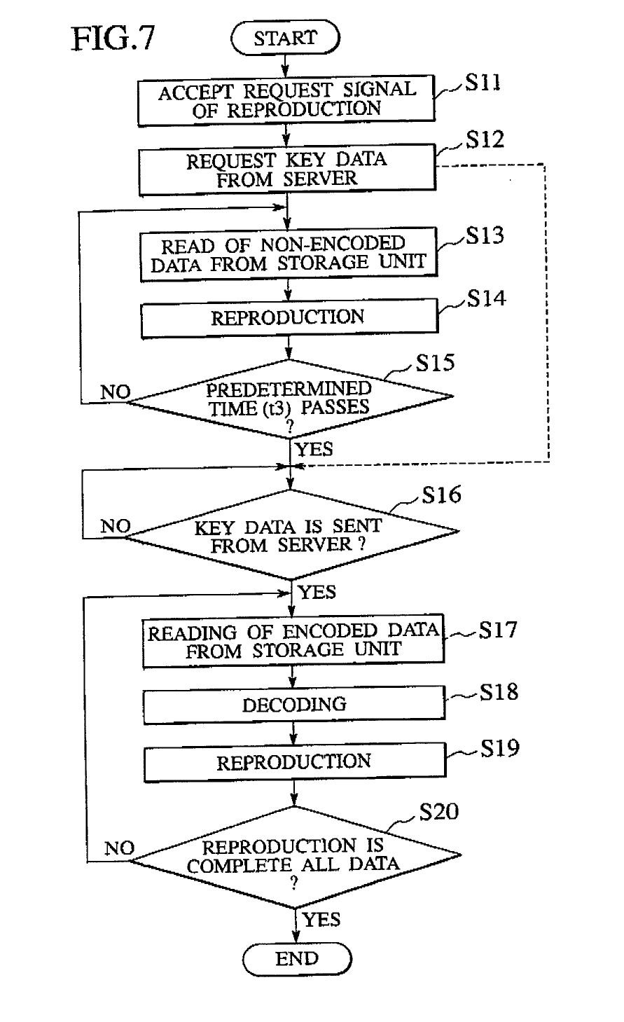

In a second embodiment, an example of carrying out “the reproduction of the precedence data part of the digital data” after “the request of the key data from the server” is explained in consonance with a flow chart shown in FIG. 7.

In step S11, the input unit 101 of client 100a accepts the request signal for reproduction of the digital data from the user.

In step S12, with the request signal to reproduce as a trigger, the control unit 102 controls the communication unit 103 to request the key data for decoding the code of the following data part 10b of the digital data from the server 200. The communication unit 103 sends a request signal for the key data from the server 200 over the communications network 300.

Afterwards, in step S13, the control unit 102 sends a reading start signal to the multiplexing unit 106, the multiplexing unit 106 starts reading out the preceding data part 10a of the digital data stored in the storage unit 104 and sends the read preceding data part 10a of the digital date to the reproduction unit 107 sequentially. In step S14, the reproduction unit 107 reproduces and outputs the sent preceding date part 10a.

The flow of processing after step S15 is similar to the processing procedure after step S05 in the first embodiment explained by the flow chart of FIG. 6.

After starting the reading of the preceding data part 10a from the storage unit 104, the multiplexing unit 106 measures the progress time, and processing from step S13 to step S14 is repeated until the predetermined time t3 has elapsed (step S15).

In step S16, when the control unit 102 of client 100a confirms that the communication unit 103 has received the key data, the control unit 102 stores the received key data to the decoding unit 105 and sends a decode start signal to the decoding unit 105.

In step S17. the decoding unit 105 starts the reading of the following data part 10b of the digital data stored in the storage unit 104. Furthermore, in step S18, the decoding unit 105 decodes the following data part 10b of the read digital data using the key data received by the communication unit 103 and sends the decoded digital data to the multiplexing unit 106. The multiplexing unit 106 sends the decoded following data part 10b to the reproduction unit 107 to follow on from the preceding data part 10a sequentially.

In step S19, the reproduction unit 107 reproduces and outputs the sent following data part 10b. Until all the processing of the following data part 10b is finished, processing from step S27 to step S19 is repeated (step S20).

By the above-mentioned processing procedure, the client 100a is able to carry out “the reproduction for the preceding data part of the digital data” after “the request of the key data from the server”.

### Third Embodiment

In the first and second embodiments, the multiplexing unit 106 of client 100a changes the processing with the preceding data part 10a and the processing with the following data part 10b based on the predetermined time t3 corresponding to a length determine as the preceding data part 10a of the digital data.

In a third embodiment, a coding start signal 12 is interposed between the preceding data part 10a and the following data part 10b of the digital data in advance as shown in FIG. 4C. Moreover, the multiplexing unit 106 of client 100a changes the processing with the preceding data part 10a and the processing with the following data part 10b by the coding start signal 12.

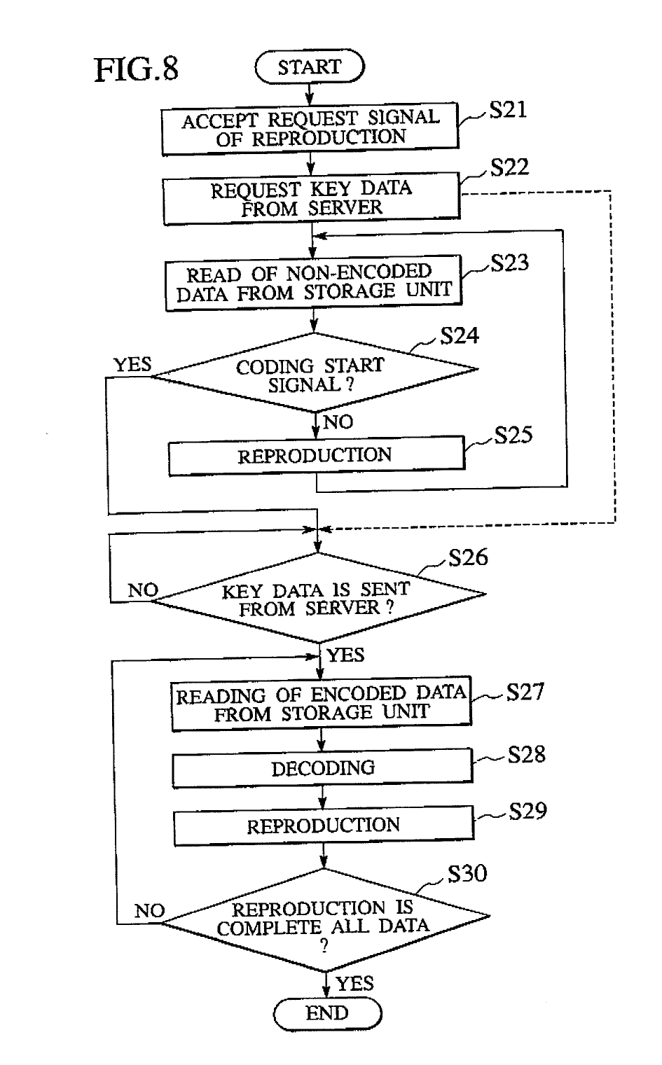

At first, as shown in FIG. 8, the input unit 101 of the client 100a accepts the request signal for reproduction of the digital data from the user in step S21.

In step S22, the control unit 102 of the client 100a controls the communication unit 103 to request the key data for decoding the following data part 10b of the digital data from the server 200. The communication unit 103 sends a request signal for the key data from the server 200 over the communications network 300.

Instep S23, the control unit 102 sends a reading start signal to the multiplexing unit 106. The multiplexing unit 106 starts the reading of the preceding data part 10a of the digital data stored in the storage unit 104.

In step S24, the multiplexing unit 106 determines whether the read digital data is the coding start signal 12, if the read digital data is not the coding start signal 12 then the multiplexing unit 106 recognizes the preceding date part 10a as still reading. In addition, in step S25, the multiplexing unit 106 sends the read preceding data part 10a to the reproduction unit 107. The reproduction unit 107 reproduces and outputs the sent preceding data part 10a.

In the judgment processing of step S24, if the read digital data is the coding start signal 12 then the multiplexing unit 106 recognizes that the preceding data part 10a has finished and it is replaced by the following data part 10b, and the multiplexing unit 106 processes the following data part 10b.

The flow of processing after step S26 is similar to the processing procedure after step S16 in the second embodiment explained by the flow chart of FIG. 7.

In step S26. when the control unit 102 of client 100a confirms that the communication unit 103 has received the key data, the control unit 102 stores the received key data to the decoding unit 105 and sends a decode start signal to the decoding unit 105.

In step S27, the decoding unit 105 starts the reading of the following data part 10b of the digital data stored in the storage unit 104. Furthermore, in step S28, the decoding unit 105 decodes the following data part 10b of the read digital data using the key data received by the communication unit 103 and sends the decoded digital data to the multiplexing unit 106. The multiplexing unit 106 sends the decoded following data part 10b to the reproduction unit 107 to follow on from the preceding data part 10a sequentially.

In step S29, the reproduction unit 107 reproduces and outputs the sent following data part 10b. Until all the processing of the following data part 10b is finished, processing from step S27 to step S29 is repeated (step S30).

In the third embodiment, the client 100a carries out “the reproduction for the precedence data unit of the digital data” after “the request of the key data from the server”, the same as in the second embodiment. The client 100a is able to carry out “the reproduction of the precedence data part of the digital data” before “the request of the key data from the server”, the same as in the first embodiment. The client 100a is also able to carry out both of “the reproduction of the precedence data part of the digital data” and “the request of the key data from the server” simultaneously, the same as in the first embodiment.

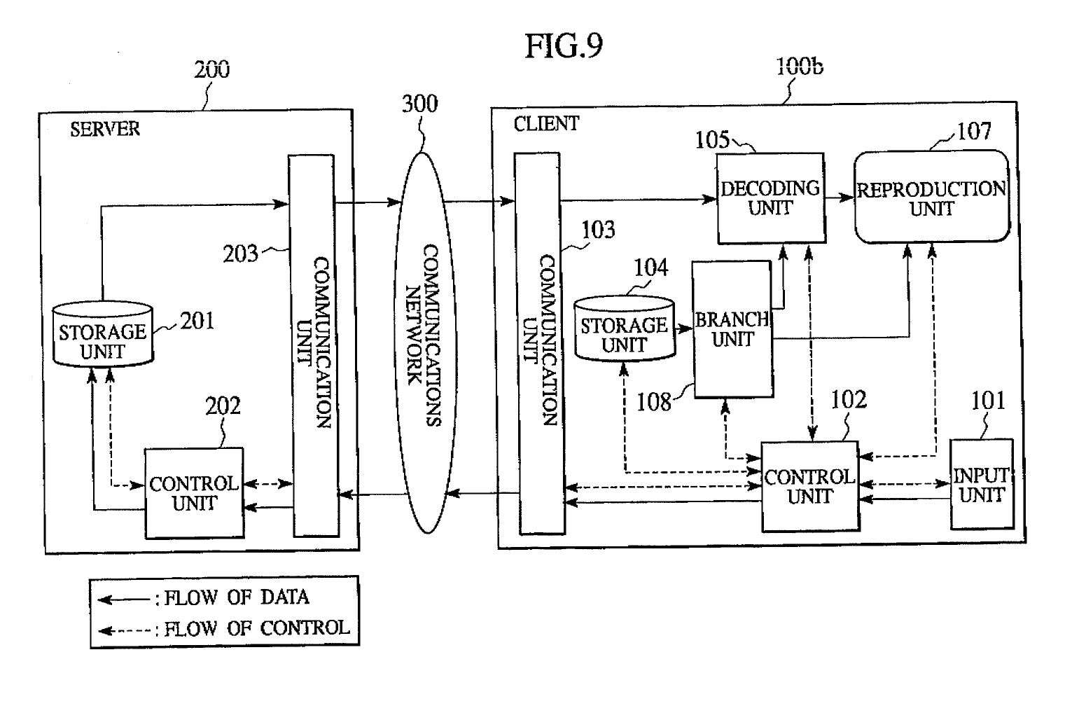

In addition, as shown in FIG. 9, a branch unit 108 is arranged in a client 100b. The branch unit 108 determines the digital data read from the storage unit 104 and branches off processing.

As shown in FIG. 9, a video on demand system includes the client 100b as a data reproducing apparatus and a server 200. The client 100b and the server 200 are connected in a communications network 300 of Internet.

The client 100b includes an input unit 101, a control unit 102, a communication unit 103, a storage unit 104, a decoding unit 105, the branch unit 106, and a reproduction unit 107.

The control unit 102 controls the communication unit 103 to request the key data for decoding the code of the following data part 10b of the digital data from the server 200, when the input unit 101 accepts the request signal for reproduction from a user. The control unit 102 sands the reading start signal to the multiplexing unit 106.

The branch unit 108 starts the reading of the digital data from the storage unit 104. and the branch unit 108 sends the read digital data to the reproduction unit 107 when the read digital data is preceding data part 10a. The reproduction unit 107 reproduces the digital data sent from the branch unit 108.

However, the branch unit 108 sends the read digital data to the decoding unit 105 when the read digital data is following data part 10b. The decoding unit 105 decodes the following data part 10b of the digital data sent from the branch unit 108 using the key data received by the communication unit 103. The decoding unit 105 sends the decoded following data part 10b to the reproduction unit 107. The reproduction unit 107 reproduces the digital data sent from the branch unit 108.

### Fourth Embodiment

In the first, second and third embodiments, the digital data such as sound or video were distributed to the user in advance, and the distributed digital data is stored in the storage unit 104 of the client 100a.

In a fourth embodiment, a processing system of streaming reproduction while reading the digital data from the server 200 is explained.

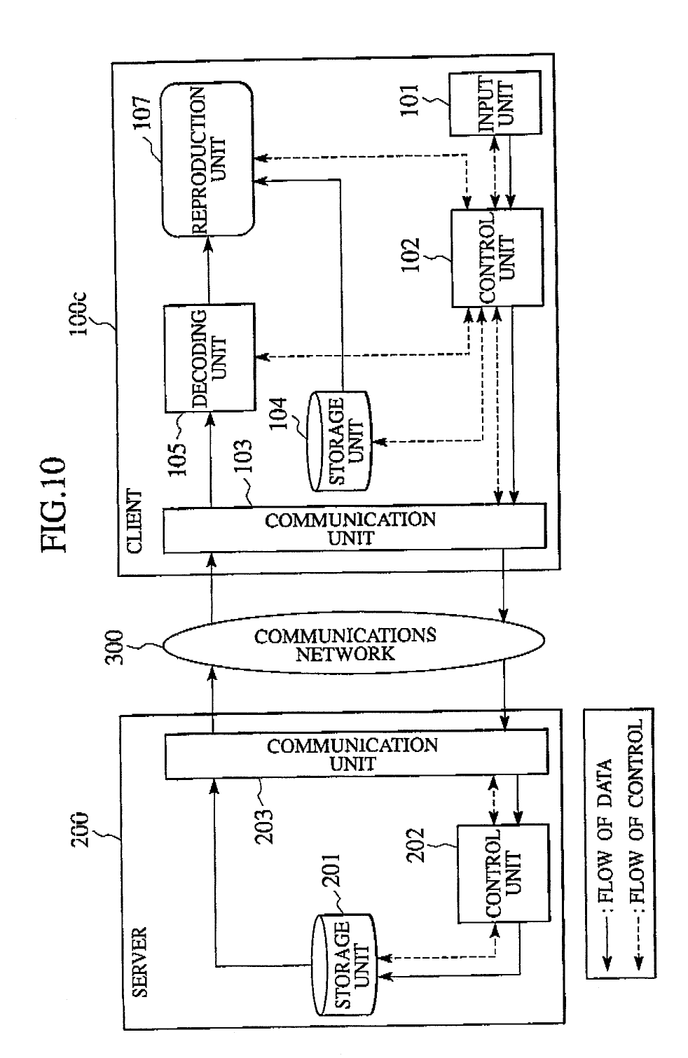

As shown in FIG. 10, a video on demand system in the fourth embodiment includes a client 100c as a data reproducing apparatus and a server 200, the client 100c and the server 200 are connected in a communications network 300 of Internet. The client 100c as the data reproducing apparatus includes an input unit 101, a control unit 102, a communication unit 103, a storage unit 104, a decoding unit 105. and a reproduction unit 107.

In the video on demand system in the fourth embodiment, only the non-encoded preceding data part 10a for predetermined length from the top of the digital data is distributed to the user in advance. Moreover, the preceding data part 10a is stored in the storage unit 104 in the client 100c in advance. A storage unit 201 of the server 200 stores the following data part 10b of the digital data encoded by the predetermined code system and the key data in advance.

The input unit 101 of the client 100c accepts a request signal for reproduction of the digital data from the user. The communication unit 103 requests the key data and the following data part 10b of the digital data from the server 200. The decoding unit 105 decodes the following data part of the digital data received by the communication unit 103 using the key data received by the communication unit 103, and the decoding unit 105 sends the decoded digital data to reproduction unit 107. The reproduction unit 107 reads the preceding data part 10a of the digital data from the storage unit 104, and the reproduction unit 107 reproduces the digital data sent by the decoding unit 105.

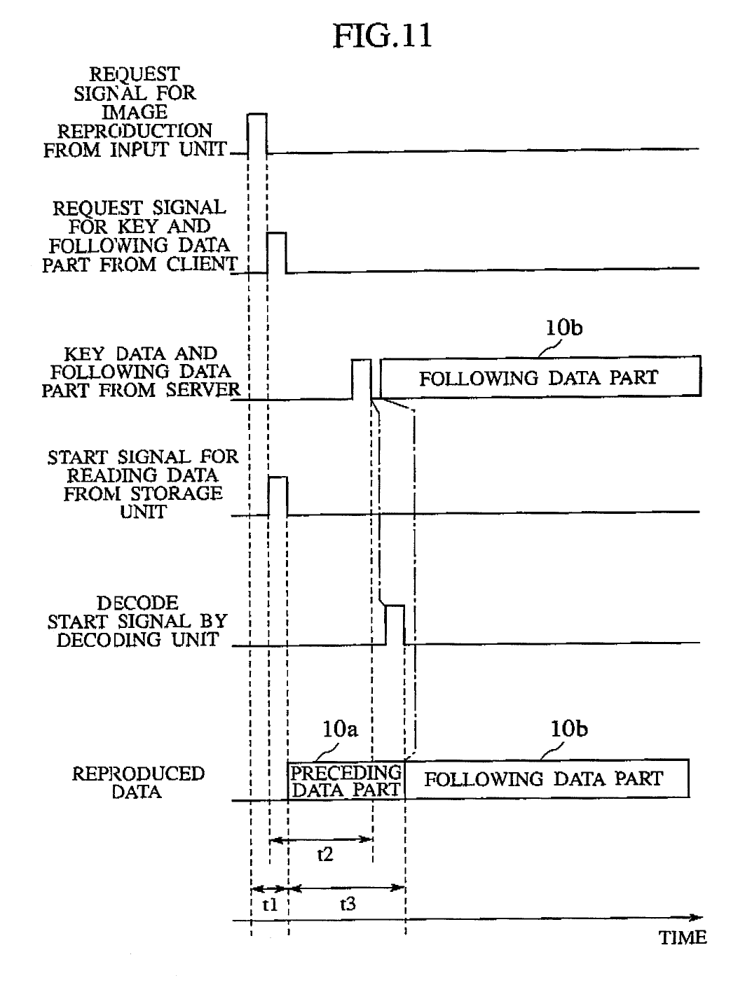

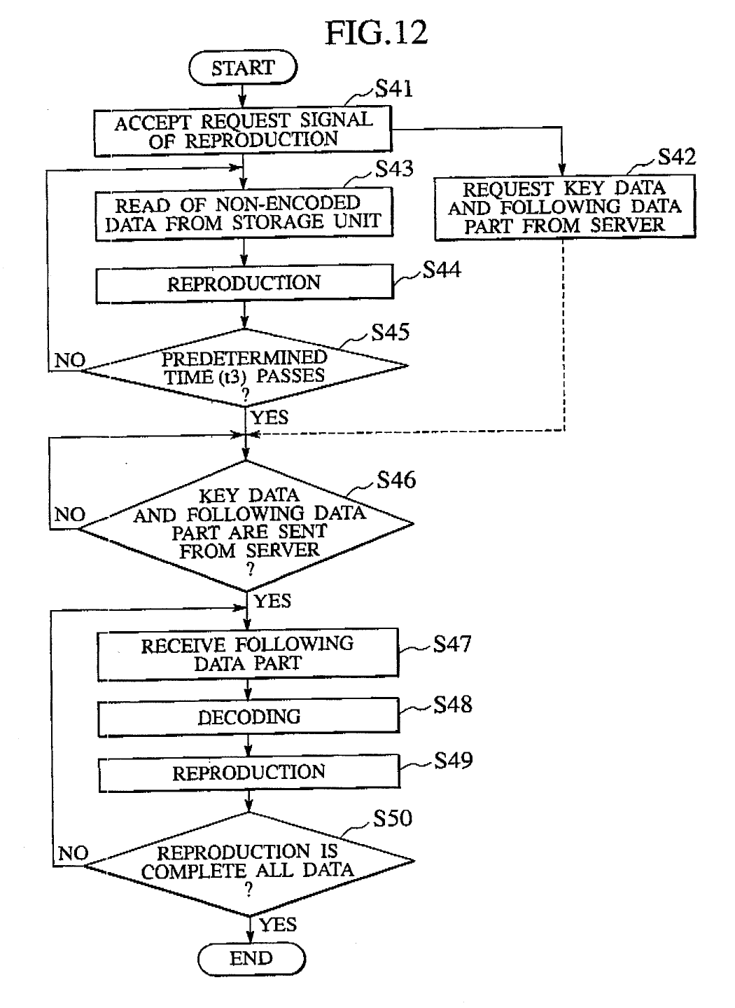

Next, a processing operation of the video on demand system in the fourth embodiment will be described based on a timing chart shown in FIG. 11 and a flow chart shown in FIG. 12.

At first, in step S41, the input unit 101 of client 100c accepts the request signal for reproduction of the digital data from the user.

The control unit 102 of the client 100c carries out the processing (a) and (b) in parallel with the request signal to reproduce as a trigger.

(a) In step S42, the control unit 102 controls the communication unit 103 to request the key data and the following data part 10b of the digital data from the server 200. The communication unit 103 sends a request signal for the key data and the following data part 10b to server 200 over the communications network 300.

(b) Instep S43, the control unit 102 sends a reading start signal to the reproduction unit 107, the reproduction unit 107 starts the reading of the preceding data part 10a of tire digital data stored in the storage unit 104. Moreover, in step S44, reproduction unit 107 reproduces and outputs the read preceding data part 10a of the digital data a sequentially.

In step 545, the reproduction unit 107 repeats the processing of step S43 to step S45 until the predetermined time t3 has elapsed.

In the meantime, the control unit 202 of server 200 accepts the request for the key data and the following data part 10b received by the communication unit 203 from the client 100c over the communications network 300. The control unit 202 reads the key data and the following data part 10b stored in the storage unit 201. The communication unit 203 transmits the read key data to the client 100c.

When the control unit 102 of client 100c confirms that the communication unit 103 has received the key data and the following data part 10b in step S46, the control unit 102 sends the received key data to the decoding unit 105 and sends a decode start signal to the decoding unit 105 in step S47.

In step S48, the decoding unit 105 decodes the following data part 10b of the digital data received by the communication unit 103 using the sent key data, the decoding unit 105 sends the decoded digital data to the reproduction unit 107.

In step S49, the reproduction unit 107 reproduces and outputs the sent following data part 10b. Until all the processing of the following data part 10b is finished, processing from step S47 to step S49 is repeated (step S50).

As thus described, in the system of streaming reproduction, while reading the digital data from the server 200, the client 100c is able to go ahead with reproduction of the preceding data part 10a without depending on the response time t2 of the key data from server 200. Therefore, the access time t1 from the user's instruction to reproduce until the reproduction of the digital data is actually started can be greatly reduced.

The system explained in the fourth embodiment has to distribute only the preceding data part 10a of the digital data to the client 100c of the user in advance, therefore the system does not need to distribute all digital data including following data 10b. Therefore, the carrying type information terminal, having a capacity of storage unit 104 that is comparatively small, such as for example a cellular phone and a Personal Digital Assistant (PDA) can be composed as the client 100c.

As thus described, once the instruction to reproduce is made by the user, requesting of the key data for decoding from the server and reproduction of the preceding data part of the digital data is done in parallel. Therefore, the client goes ahead with reproduction of the non-encoded preceding data part until the key data has been sent by the server. Once the key data has been sent by the server, while decoding the encoded following data part, the client is able to reproduce the following data part following on from the reproduction of the preceding data part. In this way, the client is able to go ahead with reproduction of the preceding data part without depending on the response time of the key data from the server. Therefore, the access time from the user's instruction to reproduce until the reproduction of the digital data is actually started can be greatly reduced.

In addition, in the system of streaming reproduction while reading the digital data from the server, the client is able to go ahead with reproduction of the preceding data part 10a without depending on the response time of the key data from the server. Therefore, the access time from the user's instruction to reproduce until the reproduction of the digital data is actually started can be greatly reduced.

Although the embodiments of the present invention have been described in detail, the invention may be embodied in other specific forms without departing from the spirit or essential characteristics thereof. The present embodiment :is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An apparatus for reproducing digital data, the apparatus configured to decode the encoded digital data using key data acquired from a server and to reproduce the decoded digital data, the apparatus comprising:
a storage unit configured to store the digital data including a non-encoded preceding data part and an encoded following data part, coming after the preceding data part;
an input unit configured to accept instruction to reproduce the digital data stored in the storage unit;
a communication unit configured to request key data for decoding the following data part from the server and to receive the key data from the server;
a decoding unit configured to decode the following data part of the digital data stored in the storage unit using the key data received by the communication unit;
a reproduction unit configured to reproduce the digital data; and
a control unit configured to control each of the unit to request the key data from the server with the communication unit and to reproduce the preceding data part of the digital data with the reproduction unit in parallel, with instructing reproduction with the input unit, to decode the following data part of the digital data with the decoding unit using the key data received by the communication unit, and to reproduce the following data part decoded by the decoding unit after reproducing the preceding data part of the digital data by the reproduction unit.

2. The apparatus of claim 1, further comprising
a multiplexing unit configured to send the following data part of the digital data decoded in the decoding unit to the reproduction unit, following on from the preceding data part of the digital data stored by the storage unit sequentially.

3. The apparatus of claim 1, further comprising
a branch unit configured to send the preceding data part of the digital data stored in the storage unit to the reproduction unit and to send the following data part to the decoding unit.

4. The apparatus of claim 1, wherein the preceding data part is reproduced by the reproduction unit after the requesting of the key data from the server by the communication unit.

5. The apparatus of claim 1, wherein the length of the preceding data part in the digital data is longer than the time from the request of the key data from the server with the communication unit until the receiving of the key data from the server with the communication unit.

6. The apparatus of claim 1, wherein a signal distinguishing between the preceding data part and the following data part Ii interposed between the preceding data part and the following data parts in the digital data.

7. An apparatus for reproducing digital data, the apparatus configured to decode the encoded digital data using key data acquired from a server and to reproduce the decoded digital data, the apparatus comprising:
a storage unit configured to store a non-encoded preceding data part of the digital data;
an input unit configured to accept instruction to reproduce the digital data;
a communication unit configured to request an encoded following data part, coming after the preceding data part, and the key data for decoding the following data part from the server and to receive the key data from the server;
a decoding unit configured to decode the following data part of the digital data using the key data received by the communication unit;
a reproduction unit configured to reproduce the digital data; and
a control unit configured to control each of the unit to request the key data and the following data part from the server with the communication unit and to reproduce the preceding data part of the digital data with the reproduction unit in parallel, with instructing reproduction with the input unit, to decode the received following data part of the digital data with the decoding unit using the key data received by the communication unit, and to reproduce the following data part decoded by the decoding unit after reproducing the preceding data part of the digital data by the reproduction unit.

8. The apparatus of claim 7, further comprising
a multiplexing unit configured to send the following date part of the digital data decoded in the decoding unit to the reproduction unit, following on from the preceding data part of the digital data stored by the storage unit sequentially.

9. The apparatus of claim 7, further comprising
a branch unit configured to send the preceding data part of the digital data stored in the storage unit to the reproduction unit and to send the following data part to the decoding unit.

10. The apparatus of claim 7, wherein the preceding data part is reproduced by the reproduction unit after the requesting of the key data from the server by the communication unit.

11. The apparatus of claim 7, wherein the length of the preceding data part in the digital data is longer than the time from the request of the key data from the server with the communication unit until the receiving of the key data from the server with the communication unit.

12. A computer implemented method for decoding encoded digital data using key data acquired from a server and for reproducing the decoded digital data, the method comprising:
accepting instruction to reproduce the digital data, stored in a storage unit, including a non-encoded preceding data part and an encoded following data part, coming after the preceding data part;
requesting the key data for decoding the following data part front the server with a communication unit;
reproducing the preceding data part of the digital date with a reproduction unit in parallel with the requesting of the key data;
receiving the key data from the server with the communication unit;
decoding the following data part of the digital data with a decoding unit using the received key data; and
reproducing the decoded following data part by the reproduction unit after reproducing the preceding data part of the digital data.

13. The computer implemented method of claim 12, wherein the preceding data part is reproduced by the reproduction unit after the requesting of the key data from the server by the communication unit.

14. A computer implemented method for decoding encoded digital data using key data acquired from a server and for reproducing the decoded digital data, the method comprising:
accepting instruction to reproduce the digital data, stored in a storage unit, including a non-encoded preceding data part;
request an encoded following data part, coming after the preceding data part, and the key data for decoding the following data part from the server with a communication unit;
reproducing the preceding data part of the digital data with a reproduction unit in parallel with the requesting of the key data and the following data part;
receiving the key data and the following data part from the server with the communication unit;
decoding the following data part with a decoding unit using the received key data; and
reproducing the decoded following data part by the reproduction unit after reproducing the preceding data part of the digital data.

15. The computer implemented method of claim 14, wherein the preceding data part is reproduced by the reproduction unit after the requesting of the key data from the server by the communication unit.

16. A computer readable recording medium storing a program for decoding encoded digital data using key data en acquired from a server and for reproducing the decoded digital data, the program comprising:
accepting instruction to reproduce the digital data, stored in a storage unit, including a non-encoded preceding data part and an encoded following data part, coming after the preceding data part;
requesting the key data for decoding the following data part from the server with a communication unit;
reproducing the preceding data part of the digital data with a reproduction unit in parallel with the requesting of the key data;
receiving the key data from the server with the communication unit;
decoding the following data part of the digital data with a decoding unit using the received key data; and
reproducing the decoded following data part by the reproduction unit after reproducing the preceding data part of the digital data.

17. The recording medium of claim 16, the program wherein the preceding data part is reproduced by the reproduction unit after the requesting of the key data from the server by the communication unit.

18. A computer readable recording medium storing a program for decoding encoded digital data using key data acquired from a server and for reproducing the decoded digital data, the program comprising:
accepting instruction to reproduce the digital data, stored in a storage unit, including a non-encoded preceding data part;
requesting an encoded following data part, coming after the preceding data part, and the key data for decoding the following data part from the server with a communication unit;
reproducing the preceding data part of the digital data with a reproduction unit in parallel with the requesting of the key data and the following data part;
receiving the key data and the following data part from the server with the communication unit;
decoding the following data part with a decoding unit using the received key data; and
reproducing the decoded following data part by the reproduction unit after reproducing the preceding data part of the digital data.

19. The recording medium of claim 18, the program wherein the preceding data part is reproduced by the reproduction unit after the requesting of the key data from the server by the communication unit.

20. A system of video on demand for decoding encoded digital data using key data and for reproducing the decoded digital data, the system comprising:
a server configured to store the key data for decoding the encoded digital data; and
a client configured to store the digital data including a non-encoded preceding data part and an encoded following data part, coming after the preceding data part, in a storage unit,
to request the key data from the server with a communication unit and to reproduce the preceding data part of the digital data with a reproduction unit in parallel, with instructing reproduction with an input unit,
to decode the following data part of the digital data with a decoding unit using the key data received by the communication unit from the server, and
to reproduce the following data part decoded by the decoding unit after reproducing the preceding data part of the digital data by the reproduction unit.

21. A system of video on demand for decoding encoded digital data using key data and for reproducing the decoded digital data, the system comprising:
a server configured to store an encoded following data part of the digital data and the key data for decoding the following data part; and
a client configured to store a non-encoded preceding data part of the digital data in a storage unit,
to request the key data and the following data part from the server with a communication unit and to reproduce the preceding data part of the digital data with a reproduction unit in parallel, with instructing reproduction with an input unit,
to decode the received following data part of the digital data with a decoding unit using the key data received by the communication unit from the server, and
to reproduce the following data part decoded by the decoding unit after reproducing the preceding data part of the digital data by the reproduction unit.
